(19) United States
(12) Patent Application Publication
(10) Pub. No.: US 2008/0187314 A1
(43) Pub. Date: Aug. 7, 2008

(54) REFLECTIVE SEMICONDUCTOR OPTICAL AMPLIFIER-BASED OPTICAL ACCESS NETWORK SYSTEM HAVING IMPROVED TRANSMISSION QUALITY

(75) Inventors: Yun Chur CHUNG, Daejeon (KR); Sang Yub KIM, Daejeon (KR); Sang Bae JUN, Daejeon (KR); Seung Pil JUNG, Daejeon (KR)

Correspondence Address: H.C. PARK & ASSOCIATES, PLC, 8500 LEESBURG PIKE, SUITE 7500, VIENNA, VA, 22182, US

(73) Assignee: KOREA ADVANCED OF SCIENCE AND TECHNOLOGY, Daejeon (KR)

(21) Appl. No.: 11/850,331

(22) Filed: Sep. 5, 2007

(30) Foreign Application Priority Data
Feb. 6, 2007 (KR) 10-2007-0012084

(51) Int. Cl. H04J 14/00

(52) U.S. Cl. 398/72

(57) ABSTRACT

Disclosed herein is an optical access network system in which the transmission quality of an upstream signal is remarkably improved in an optical access network in which a Reflective Semiconductor Optical Amplifier (RSOA) is used as the light source for each subscriber. The most important characteristics of the present invention are that a Manchester modulation format is used as a modulation format for a downstream signal in an optical access network system in which an RSOA is used as the light source for each subscriber, so that the problem of deterioration of the transmission quality of a remodulated upstream signal, occurring when an RSOA is used as the light source for each subscriber, is solved, and thus the transmission performance of an upstream signal and the power budget performance of the entire system are improved. According to the present invention, an RSOA-based WDM PON system, in which performance at a power budget and the transmission performance of a remodulated upstream signal are improved, can be implemented.

### CROSS REFERENCE TO RELATED APPLICATION

This application claims priority from and the benefit of Korean Patent Application No. 10-2007-0012084, filed on Feb. 6, 2007, which is hereby incorporated by reference for all purposes as if fully set forth herein.

### BACKGROUND OF THE INVENTION

1. Field of the Invention

The present invention relates, in general, to optical access network systems, and, more particularly, to an optical access network system, which modulates a downstream signal in a Manchester format in an optical access network, in which a Reflective Semiconductor Optical Amplifier (RSOA) is used as the light source for each subscriber, thus remarkably improving the transmission quality of a remodulated upstream signal.

2. Description of the Related Art

Recently, with the development of future communication services along with the increase in the use of the Internet, an increase in transmission capacity has been urgently required. In order to meet this requirement, research on optical access network systems that enable an optical fiber to be connected to each subscriber and are capable of transmitting data to the subscriber at a very high speed and over a wide band has been actively conducted. Of the optical access networks, a Passive Optical access network (PON) uses only passive optical devices, such as optical fiber, a multiplexer/demultiplexer, a splitter, and a connector, for the configuration of a network for connecting a central office to each subscriber. Therefore, the PON is advantageous in that the maintenance and management of networks are made easy, and the supply of separate power is not required.

In particular, since a Wavelength Division Multiplexing (WDM) PON enables a transmission channel to be formed using unique wavelengths for respective subscribers, it is advantageous in that it is favorable to increases in transmission capacity, security and extensibility. However, the WDM PON is disadvantageous in that, since light sources operating at different wavelengths must be installed for respective subscribers, installation costs increase.

In order to eliminate this disadvantage, methods using light sources, such as a spectrum-sliced Light Emitting Diode (LED), an Amplified Spontaneous Emission (ASE) injection Fabry-Perot Laser-Diode (FP-LD) (hereinafter referred to as an “ASE injection FP-LD”), and a Reflective Semiconductor Optical Amplifier (RSOA), have been proposed. Of the light sources, the spectrum-sliced LED is problematic in that, since power consumption is large when spectrum slicing occurs, output power is low. Further, the ASE injection FP-LD is disadvantageous in that an expensive broadband light source must be additionally installed in a central office. In contrast, when the RSOA is used as the light source for each subscriber, a downstream signal input from the RSOA is amplified/remodulated and is used as an upstream signal, and thus output power is sufficiently high and there is no need to install an additional broadband light source in a central office. For this reason, research on WDM PON, in which an RSOA is used as the light source for each subscriber, has recently been actively conducted.

However, when an RSOA is used as a subscriber light source, there is a problem in that the transmission quality of an upstream signal is influenced by the characteristics of the downstream signal input to the RSOA due to the features of the RSOA, which amplifies/remodulates a downstream signal to generate an upstream signal. When the power of the downstream signal, input to the RSOA, is sufficiently high, and thus the RSOA is operated in a saturation region, the transmission quality of the upstream signal, generated by amplifying/remodulating the downstream signal, is not degraded. However, when the power of the downstream signal, input to the RSOA, is low, the RSOA is operated in a linear region, thus rapidly degrading the transmission quality of the upstream signal. Further, when the extinction ratio of a downstream signal is high, the noise characteristics of the high-level components of a remodulated upstream signal are deteriorated, and thus the transmission quality of the upstream signal is further degraded [Cited document: Wooram Lee, et al., “Bidirectional WDM-PON Based on Gain-Saturated Reflective Semiconductor Optical Amplifier,” IEEE Photonics Technology Letters, vol. 17, no. 11, November 2005]. Therefore, in the WDM PON in which the RSOA is used as the light source for each subscriber, the RSOA must be operated in a saturation region in order to prevent the degradation of the transmission performance of an upstream signal from occurring due to the presence of a downstream signal. However, for this operation, there occur several problems in that the power of the downstream signal, input to the RSOA, must be sufficiently high, and the extinction ratio of the downstream signal cannot be increased to a certain degree or more.

In order to solve these problems, prior research was conducted using a method of modulating a downstream signal through Frequency Shift Keying (FSK) modulation. However, this method is not fit to be used in an optical access network, in which economic efficiency is considered important, because a transmitting laser capable of performing FSK modulation is required to generate a downstream signal, and an FSK receiver is also required at the time of reception.

### SUMMARY OF THE INVENTION

Accordingly, the present invention has been made keeping in mind the above problems occurring in the prior art, and an object of the present invention is to provide an optical access network system, which prevents the degradation of the transmission quality of an upstream signal from occurring due to the presence of a downstream signal in an optical access network system in which an RSOA is used as the light source for each subscriber, thus improving not only the transmission quality of the upstream signal, but also the power budget performance of the entire system.

In order to accomplish the above object, the present invention provides an optical access network system in an optical access network in which a Reflective Semiconductor Optical Amplifier (RSOA) is used as a light source for each subscriber, wherein the optical access network system uses a Manchester format as a modulation format for modulating a downstream signal, which is transmitted from a Central Office (CO) to each Optical access network Unit (ONU).

Preferably, the optical access network may be a Wavelength Division Multiplexing (WDM) Passive Optical access network (PON). In this case, the WDM PON may have a unidirectional structure or a bidirectional structure.

When the WDM PON has a unidirectional structure, the WDM PON may comprise the central office, including one or more light sources for generating downstream signals, a Manchester signal generation unit for directly modulating the downstream signals emitted from the light sources in a Manchester format, a first Arrayed Waveguide Grating (AWG) for multiplexing the modulated downstream signals in a wavelength division multiplexing manner, a second AWG for demultiplexing an upstream signal, transmitted from each ONU, for respective wavelengths, and one or more upstream signal receivers for receiving upstream signals, obtained through demultiplexing for respective wavelengths while causing components of a downstream signal, modulated in the Manchester format and included in each of the upstream signals, to be eliminated by a limited bandwidth; a remote node including an optical coupler for dividing each of the downstream signals, a third AWG for performing demultiplexing for respective wavelengths, a circulator for determining transmission paths of upstream/downstream signals, and a fourth AWG for generating an upstream signal; a plurality of Optical access network Units (ONUs), each including a receiver for recovering a downstream signal, and an RSOA for generating an upstream signal; and upstream and downstream transmission optical fibers separately provided and adapted to connect the central office with the remote node, and connect the remote node with each ONU.

Preferably, the Manchester signal generation unit may comprise a Non-Return-to-Zero (NRZ) signal provision unit, a clock signal provision unit, and an XOR gate.

Meanwhile, when the WDM PON has a bidirectional structure, the WDM PON may comprise the central office, including one or more light sources for generating downstream signals, a Manchester signal generation unit for directly modulating the downstream signals emitted from the light sources in a Manchester format, a first Arrayed Waveguide Grating (AWG) for multiplexing the modulated downstream signals in a wavelength division multiplexing manner, a circulator for determining transmission paths of upstream/downstream signals, a second AWG for demultiplexing an upstream signal, transmitted from each ONU, for respective wavelengths, and one or more upstream signal receivers for receiving upstream signals, obtained through demultiplexing for respective wavelengths while causing components of a downstream signal, modulated in the Manchester format and included in each of the upstream signals, to be eliminated by a limited bandwidth; a remote node including a third AWG for performing demultiplexing on each of the downstream signals for respective wavelengths; a plurality of Optical access network Units (ONUs), each including a receiver for recovering a downstream signal, an RSOA for generating an upstream signal, and an optical coupler for dividing the downstream signal and separately transmitting respective division parts thereof to the receiver and the RSOA; and a common upstream/downstream transmission optical fiber for connecting the central office with the remote node, and connecting the remote node with each subscriber.

Preferably, the Manchester signal generation unit may comprise an NRZ signal provision unit, a clock signal provision unit, and an XOR gate.

Preferably, the upstream signals may be modulated in a Non-Return-to-Zero (NRZ) format, or may be modulated in a Return-to-Zero (RZ) format if necessary.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing the waveform of a downstream signal modulated in a Manchester format, which is used in an optical access network system according to the present invention, and the waveform of a downstream signal modulated in a Non-Return-to-Zero (NRZ) format, which is used in the prior art, for comparison with the present invention;

FIG. 2 is a diagram schematically showing the construction of a unidirectional WDM PON system according to a first embodiment of the present invention;

FIG. 3A is a graph showing the results of measurement of the transmission performance of an upstream signal, generated by remodulating a downstream signal, input to a Reflective Semiconductor Optical Amplifier (RSOA) as an NRZ signal, when a downstream signal modulated in an NRZ format is used, without using a Manchester signal generation unit, in the RSOA-based unidirectional WDM PON system according to the first embodiment of the present invention;

FIG. 3B is a graph showing the results of measurement of the transmission performance of an upstream signal, remodulated as an NRZ signal by the RSOA when a downstream signal, modulated in a Manchester format, is used through the use of a Manchester signal generation unit in the RSOA-based unidirectional WDM PON system according to the first embodiment of the present invention;

FIG. 4 is a graph showing the results of measurement of the electrical spectrums of downstream signals, respectively modulated in an NRZ format and in a Manchester format, to describe the reason why the transmission performance of an upstream signal of the RSOA-based unidirectional WDM PON system according to the first embodiment is improved compared to that of a conventional RSOA-based WDM PON system using an NRZ signal;

FIG. 5 is a view showing the results of measurement of the eye diagrams of upstream signals, generated by remodulating downstream signals respectively modulated in an NRZ format and in a Manchester format using an RSOA, to prove the effect by which the component of the downstream signal, modulated in the Manchester format, is included in a remodulated upstream signal and is then eliminated by the limited bandwidth of an upstream signal receiver;

FIG. 6 is a graph showing the reception sensitivities of downstream signals modulated in the NRZ and Manchester formats at a modulation rate of 1.25 Gb/s, relative to variation in the extinction ratios of the downstream signals; and

FIG. 7 is a diagram schematically showing the construction of a bidirectional WDM PON system according to a second embodiment of the present invention.

### DESCRIPTION OF THE PREFERRED EMBODIMENTS

Hereinafter, embodiments of the present invention will be described in detail with reference to the attached drawings. The embodiments are not intended to limit the scope of the present invention, but are presented to exemplify the present invention.

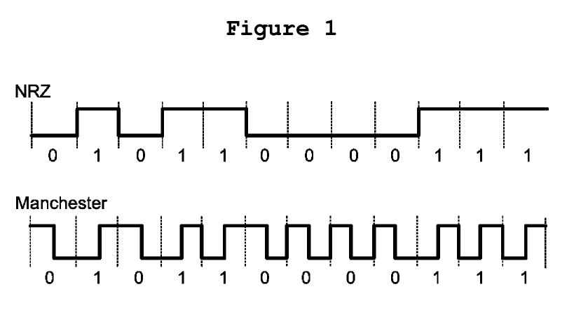

FIG. 1 is a graph showing the waveform of a downstream signal modulated in a Manchester format, which is used in an optical access network system according to the present invention, and the waveform of a downstream signal modulated in a Non-Return-to-Zero (NRZ) format, which is used in the prior art, for comparison with the present invention. The reason for comparatively showing the two signals is to modulate downstream signals in an NRZ format and in a Manchester format, respectively, in a Reflective Semiconductor Optical Amplifier (RSOA)-based Wavelength Division Multiplexing (WDM) Passive Optical access network (PON) and to analyze the transmission qualities of the upstream signals obtained through respective modulation formats in the following embodiments, thus demonstrating the excellence of the present invention.

### Embodiment 1

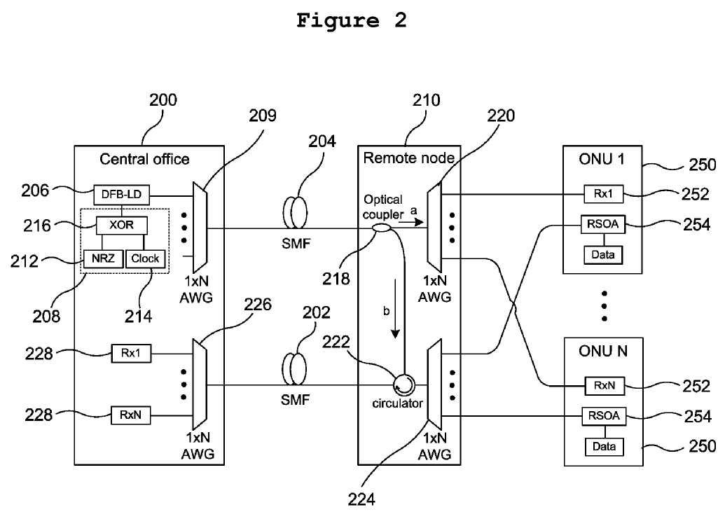

FIG. 2 is a diagram schematically showing a unidirectional WDM PON system according to a first embodiment of the present invention. This unidirectional WDM PON system uses a Manchester signal for the modulation format of a downstream signal, and uses an RSOA as the light source for each subscriber.

Referring to FIG. 2, the unidirectional WDM PON system according to the first embodiment of the present invention includes a Central Office (hereinafter referred to as a “CO”) 200, an upstream transmission optical fiber 202, a downstream transmission optical fiber 204, a remote node 210, and a plurality of subscriber units (Optical access network Units: hereinafter referred to as “ONUs”) 250. A Single Mode Fiber (SMF) is used as each of the upstream and downstream transmission optical fibers 202 and 204. The CO 200 includes light sources for generating downstream signals, for example, Distributed Feedback-Laser Diodes (DFB-LDs) 206, a first Arrayed Waveguide Grating (hereinafter referred to as ‘AWG’) 209 for multiplexing optical signals emitted from light sources corresponding to a plurality of channels in a wavelength division multiplexing manner, a second AWG 226 for demultiplexing an upstream signal for respective wavelengths, and upstream signal receivers 228 for receiving signals demultiplexed for respective wavelengths. Further, the most important characteristics of the present invention are that a Manchester signal generation unit 208, for directly modulating an optical signal, emitted from each light source for generating a downstream signal, in a Manchester format, is additionally provided. The Manchester signal generation unit 208 includes an NRZ signal provision unit 212, a clock signal provision unit 214, and an XOR gate 216.

Meanwhile, the remote node 210 includes an optical coupler 218 for dividing the downstream signal, a third AWG 220 for performing demultiplexing for respective wavelengths, a circulator 222 for determining the transmission paths of upstream/downstream signals, and a fourth AWG 224 for generating an upstream signal. Each of the ONUs 250 includes a receiver 252 for recovering a downstream signal and an RSOA 254 for generating an upstream signal.

The detailed operating principles of the system according to the first embodiment of the present invention are described below. The optical signal emitted from each DFB-LD 206 included in the CO 200 is directly modulated in a Manchester format at a modulation rate of 1.25 Gb/s, and thus a downstream signal is generated. The downstream signal passes through the first AWG 209 of the CO 200, and is transmitted to the remote node 210 through the downstream transmission optical fiber 204 between the CO 200 and the remote node 210. The optical coupler 218 placed in the remote node 210 functions to divide the downstream signal into two parts. One part (a) of the downstream signal, obtained through the division, is input to the downstream signal receiver 252 of the ONU 250 through the third AWG 220 so as to recover the downstream signal, and the remaining part (b) thereof passes through the circulator 222 and the fourth AWG 224 and is input to the RSOA 254 of the ONU 250 to generate an upstream signal. The upstream signal is generated by remodulating the downstream signal, input to the RSOA 254 in an NRZ format at a modulation rate of 155 Mb/s. The generated upstream signal passes through the fourth AWG 224 and the circulator 222 of the remote node 210, and is then transmitted to the CO 200 through the upstream transmission optical fiber 202 between the remote node 210 and the CO 200. Thereafter, the upstream signal is transmitted to an upstream signal receiver 228 having a corresponding wavelength through the second AWG 226 of the central office 200.

In the first embodiment, NRZ format modulation is used to generate upstream signals, but Return-to-Zero (RZ) format modulation can be used if necessary.

As shown in FIG. 1, when a downstream signal is modulated in an NRZ format, as in the case of the prior art, the power of the downstream signal input to the RSOA 254 is insufficient, and thus the RSOA 254 is operated in a linear region. In this case, the transmission quality of the remodulated upstream signal is deteriorated. However, when a downstream signal is modulated in a Manchester format, signal levels are not continuously uniform because of the characteristics of a Manchester signal, in which the level of the signal varies for each bit, and thus few low frequency signal components exist. Therefore, most components of a downstream signal, modulated in the Manchester format and included in the remodulated upstream signal, are eliminated by the limited bandwidth of the upstream signal receiver 228. Therefore, when the Manchester signal generation unit, characteristically employed in the system of the present invention, is used, the transmission performance of the upstream signal, remodulated by the RSOA 254, is improved compared to a conventional method of modulating a downstream signal in an NRZ format.

In order to demonstrate the excellence of the present invention, the case where an optical signal emitted from the DFB-LD 206 is directly modulated in a Manchester format at a modulation rate of 1.25 Gb/s to generate a downstream signal and the case where an optical signal emitted from the DFB-LD 206 is directly modulated in an NRZ format at a modulation rate of 1.25 Gb/s to generate a downstream signal without the Manchester signal generation unit 208, in the system according to the first embodiment of the present invention, described with reference to FIG. 2, are compared to each other.

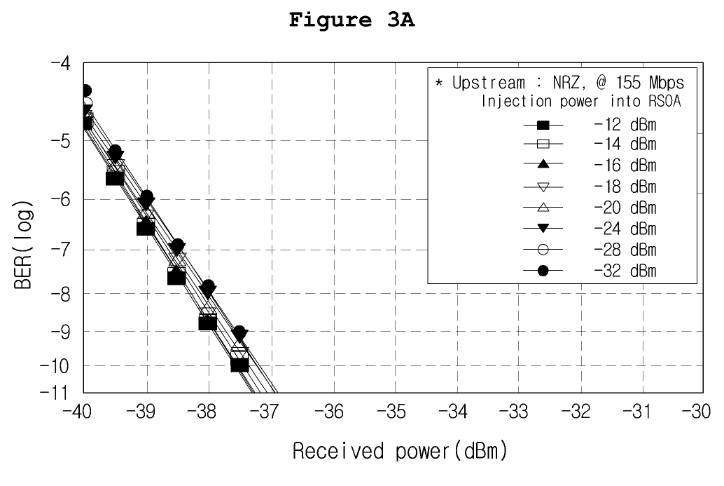

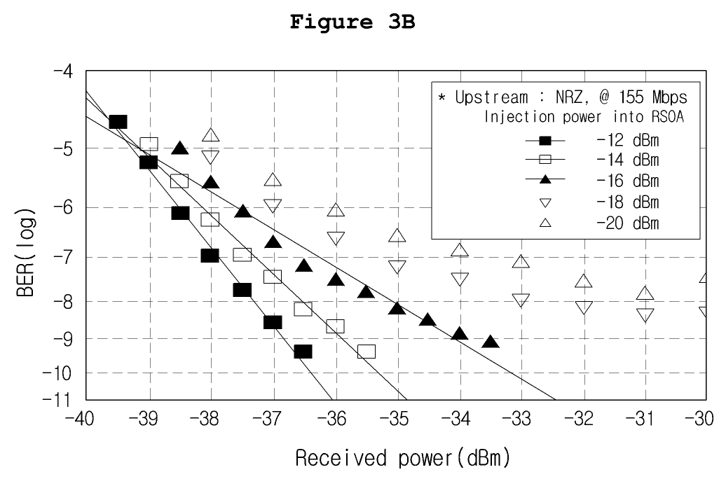

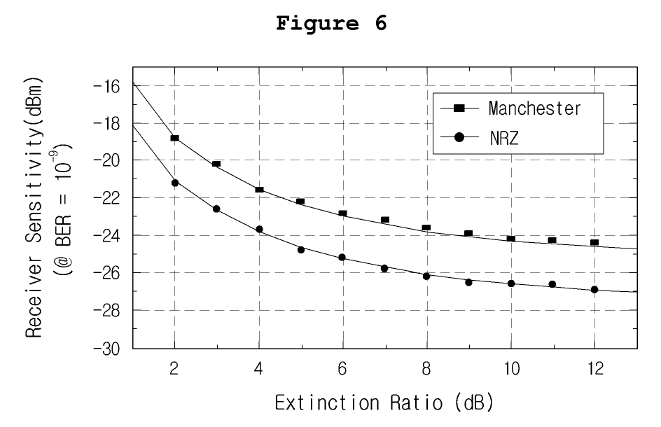

FIG. 3A is a graph showing the results of measurement of the transmission performance of an upstream signal, generated by remodulating the downstream signal input to the RSOA 254 as an NRZ signal at a modulation rate of 155 Mb/s, when the downstream signal, modulated in an NRZ format at a modulation rate of 1.25 Gb/s, is used without using the Manchester signal generation unit 208, in the RSOA-based unidirectional WDM PON system according to the first embodiment of the present invention. When the extinction ratio of a downstream signal is high, the performance of the upstream signal is rapidly degraded, and thus experiments are conducted after the extinction ratio of the downstream signal has been sufficiently decreased. At this time, as the extinction ratio is decreased, the reception sensitivity of the downstream signal receiver is decreased, and thus the transmission performance of the downstream signal is deteriorated (refer to FIG. 6). When the power of the downstream signal, input to the RSOA 254, is sufficiently high, and thus the RSOA 254 is operated in a saturation region in the case where the downstream signal having a sufficiently low extinction ratio is input to the RSOA 254, the transmission performance of the upstream signal is not deteriorated. However, it can be seen that, when the power of the downstream signal is low and thus the RSOA 254 is operated in a linear region even if the extinction ratio of the downstream signal is decreased, the performance of the upstream signal is rapidly deteriorated as the power of the downstream signal, input to the RSOA 254, is decreased.

FIG. 3B is a graph showing the results of measurement of the transmission performance of an upstream signal, remodulated as an NRZ signal at a modulation rate of 155 Mb/s by the RSOA 254, when a downstream signal, modulated in a Manchester format at a modulation rate of 1.25 Gb/s, is used through the use of the Manchester signal generation unit 208 in the RSOA-based unidirectional WDM PON system according to the first embodiment of the present invention. Unlike a conventional NRZ signal, a Manchester signal is characterized in that the transmission performance of a remodulated upstream signal is not influenced by the extinction ratio of the downstream signal. Therefore, the Manchester signal is characterized in that, even when the transmission performance of a downstream signal is improved using a downstream signal having a sufficiently high extinction ratio, the transmission performance of the upstream signal is not deteriorated. Moreover, the Manchester signal is characterized in that, even if the power of the downstream signal, input to the RSOA 254, is greatly decreased when the Manchester signal is used as the downstream signal, the transmission performance of a remodulated upstream signal is almost uniform.

That is, when the RSOA-based WDM PON system using a Manchester signal according to the first embodiment of the present invention is used, the transmission performance of the downstream signal can be improved by sufficiently increasing the extinction ratio of the downstream signal, and the transmission performance of the upstream signal is almost uniform regardless of the intensity of the input power of the RSOA even for a sufficiently large downstream signal, and thus the performance of the RSOA-based WDM PON system can be remarkably improved compared to a conventional RSOA-based WDM PON system using an NRZ signal.

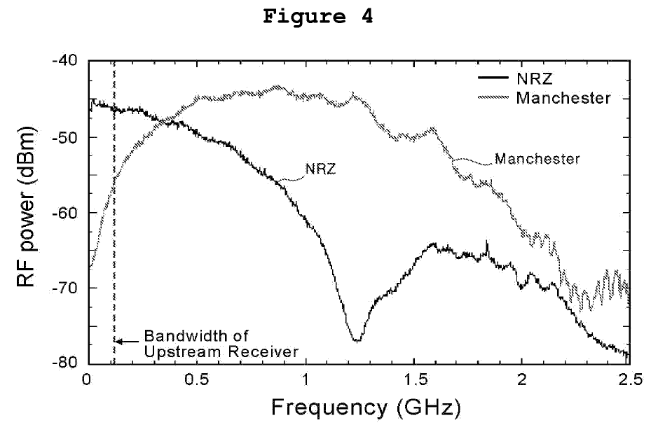

FIG. 4 is a graph showing the results of measurement of the electrical spectrums of downstream signals, respectively modulated in an NRZ format and in a Manchester format, to show the reason why the transmission performance of the upstream signal of the RSOA-based unidirectional WDM PON system according to the first embodiment is improved, compared to that of a conventional RSOA-based WDM PON system using an NRZ signal. Referring to FIG. 4, it can be seen that, in the case of a Manchester signal, few low frequency components exist due to the characteristics of the Manchester signal, by which the level of a signal varies at each bit. Therefore, the Manchester signal is characterized in that most components of the Manchester signal included in the remodulated upstream signal are eliminated by the limited bandwidth of the upstream signal receiver.

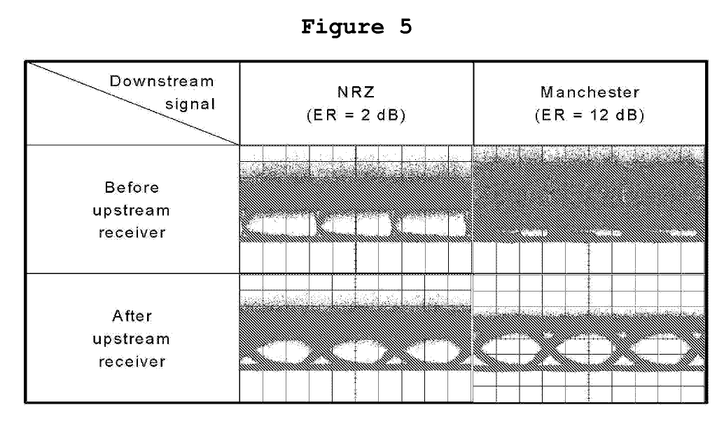

As described above, FIG. 5 is a view showing the results of measurement of the eye diagrams of upstream signals, generated by remodulating downstream signals respectively modulated in an NRZ format and in a Manchester format using an RSOA, to prove the effect by which the component of the downstream signal modulated in the Manchester format is included in a remodulated upstream signal and is then eliminated by the limited bandwidth of an upstream signal receiver. Referring to the eye diagram of the upstream signal, measured before the upstream signal passes through the upstream signal receiver (“Before upstream receiver” in FIG. 5), since the extinction ratios of different downstream signals are used depending on modulation formats, the performance of the upstream signal, measured when the downstream signal is modulated in the NRZ format, seems to be better. However, referring to the eye diagram measured after the upstream signal passed through the receiver (“After upstream receiver” in FIG. 5), it can be seen that, due to the above-described fact, the downstream signal is modulated in a Manchester format, and thus the transmission quality of the upstream signal is remarkably improved.

FIG. 6 is a graph showing the reception sensitivities of downstream signals modulated in the NRZ and Manchester formats at a modulation rate of 1.25 Gb/s, relative to variation in the extinction ratios of the downstream signals. Referring to FIG. 6, both in the two cases, it can be seen that, as the extinction ratio is decreased, the reception sensitivity of the downstream signal receiver is deteriorated, and thus the transmission performance of the downstream signal is deteriorated.

### Embodiment 2

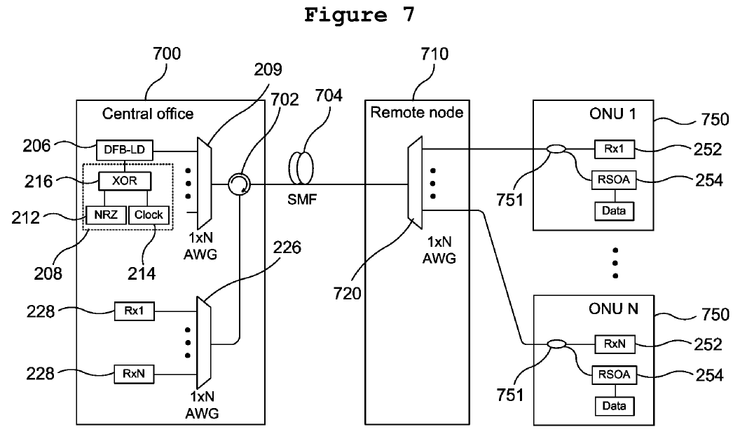

FIG. 7 is a diagram schematically showing the construction of a bidirectional WDM PON system according to a second embodiment of the present invention. This bidirectional WDM PON system is characterized in that a Manchester signal is used for the modulation format of a downstream signal, and an RSOA is used as the light source for each subscriber. In FIG. 7, the same reference numerals are used to designate the same components as those of FIG. 2, and a repeated description thereof is omitted.

The second embodiment is compared to the first embodiment below. The second embodiment is identical to the first embodiment in that it has basic components, such as a central office, a remote node, and an ONU, but differs from the first embodiment in that, in the first embodiment, upstream and downstream transmission optical fibers for connecting the central office with the remote node and connecting the remote node with the ONU are separately used, whereas, in the second embodiment, a single optical fiber is used to transmit both upstream and downstream signals. Since a single optical fiber is used to transmit upstream and downstream signals, a circulator 702 for determining the transmission paths of upstream/downstream signals is provided in the central office 700 in the second embodiment of the present invention. The second embodiment is similar to the first embodiment in that a Manchester signal generation unit 208 for directly modulating a downstream signal emitted from a light source is additionally provided. Further, the remote node 710 is provided with only a single AWG 720 for performing demultiplexing for respective wavelengths. Each ONU 750 includes an optical coupler 751 for dividing a downstream signal, a receiver 252 for recovering a downstream signal, and an RSOA 254 for generating an upstream signal.

The operation of the system according to the second embodiment of the present invention, having the above construction, is described below. First, an optical signal emitted from a given DFB-LD 206 is directly modulated in a Manchester format at a modulation rate of 1.25 Gb/s by the Manchester signal generation unit 208, and thus a downstream signal is generated. The downstream signal passes through an AWG 209 for wavelength division multiplexing and the circulator 702 for determining the transmission paths of upstream/downstream signals, and is then transmitted to the remote node 710 through an optical fiber (SMF) 704. The downstream signal, transmitted to the remote node 710, is demultiplexed by the AWG 720 of the remote node, and corresponding downstream signals are then input to respective ONUs 750. The downstream signal, input to each ONU 750, is divided into two parts by the optical coupler 751, one part of the downstream signal being input to the downstream signal receiver 252 to recover the downstream signal, and the remaining part thereof being input to the RSOA 254 to generate an upstream signal. The upstream signal, generated by remodulating the downstream signal input to the RSOA 254 in an NRZ format at a modulation rate of 155 Mb/s, is transmitted to a corresponding upstream signal receiver 228 after passing through the AWG 720 of the remote node 710, the optical fiber 704, and the circulator 702 and AWG 226 of the central office 700. As described above, although the second embodiment has been described, the difference between the first embodiment and the second embodiment resides in the determination of whether the upstream and downstream transmission optical fibers are separately used, and thus there is no difference related to the fact that the downstream signal, emitted from a light source, is directly modulated in a Manchester format to improve the transmission quality of the upstream signal.

In the second embodiment, NRZ format modulation is used to generate an upstream signal, but RZ format modulation can be used if necessary.

The above-described present invention is advantageous in that, compared to a conventional RSOA-based optical access network system that uses downstream signals modulated in an NRZ format, the transmission performance of a downstream signal can be improved by increasing the extinction ratio of downstream signals, and the transmission performance of upstream signals, remodulated by the RSOA, is not deteriorated even if the power of the downstream signals input to the RSOA is sufficiently decreased, and thus the power budget performance of the entire system can also be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical access network system in an optical access network in which a Reflective Semiconductor Optical Amplifier (RSOA) is used as a light source for each subscriber, wherein:
the optical access network system uses a Manchester format as a modulation format for modulating a downstream signal, which is transmitted from a Central Office (CO) to each Optical access network Unit (ONU).

2. The optical access network system according to claim 1, wherein the optical access network is a Wavelength Division Multiplexing (WDM) Passive Optical access network (PON).

3. The optical access network system according to claim 2, wherein the WDM PON has a unidirectional structure.

4. The optical access network system according to claim 3, wherein the WDM PON comprises:
the central office, including one or more light sources for generating downstream signals, a Manchester signal generation unit for directly modulating the downstream signals emitted from the light sources in a Manchester format, a first Arrayed Waveguide Grating (AWG) for multiplexing the modulated downstream signals in a wavelength division multiplexing manner, a second AWG for demultiplexing an upstream signal, transmitted from each ONU, for respective wavelengths, and one or more upstream signal receivers for receiving upstream signals, obtained through demultiplexing for respective wavelengths while causing components of a downstream signal, modulated in the Manchester format and included in each of the upstream signals, to be eliminated by a limited bandwidth;
a remote node including an optical coupler for dividing each of the downstream signals, a third AWG for performing demultiplexing for respective wavelengths, a circulator for determining transmission paths of upstream/downstream signals, and a fourth AWG for generating an upstream signal;
a plurality of Optical access network Units (ONUs), each including a receiver for recovering a downstream signal, and an RSOA for generating an upstream signal; and
upstream and downstream transmission optical fibers separately provided and adapted to connect the central office with the remote node, and connect the remote node with each ONU.

5. The optical access network system according to claim 4, wherein the Manchester signal generation unit comprises a Non-Return-to-Zero (NRZ) signal provision unit, a clock signal provision unit, and an XOR gate.

6. The optical access network system according to claim 2, wherein the WDM PON has a bidirectional structure.

7. The optical access network system according to claim 6, wherein the WDM PON comprises:
the central office, including one or more light sources for generating downstream signals, a Manchester signal generation unit for directly modulating the downstream signals emitted from the light sources in a Manchester format, a first Arrayed Waveguide Grating (AWG) for multiplexing the modulated downstream signals in a wavelength division multiplexing manner, a circulator for determining transmission paths of upstream/downstream signals, a second AWG for demultiplexing an upstream signal, transmitted from each ONU, for respective wavelengths, and one or more upstream signal receivers for receiving upstream signals, obtained through demultiplexing for respective wavelengths while causing components of a downstream signal, modulated in the Manchester format and included in each of the upstream signals, to be eliminated by a limited bandwidth;
a remote node including a third AWG for performing demultiplexing on each of the downstream signals for respective wavelengths;
a plurality of Optical access network Units (ONUs), each including a receiver for recovering a downstream signal, an RSOA for generating an upstream signal, and an optical coupler for dividing the downstream signal and separately transmitting respective division parts thereof to the receiver and the RSOA; and
a common upstream/downstream transmission optical fiber for connecting the central office with the remote node, and connecting the remote node with each subscriber.

8. The optical access network system according to claim 7, wherein the Manchester signal generation unit comprises an NRZ signal provision unit, a clock signal provision unit, and an XOR gate.

9. The optical access network system according to claim 4, wherein the upstream signals are modulated in a Non-Return-to-Zero (NRZ) format.

10. The optical access network system according to claim 5, wherein the upstream signals are modulated in a Non-Return-to-Zero (NRZ) format.

11. The optical access network system according to claim 7, wherein the upstream signals are modulated in a Non-Return-to-Zero (NRZ) format.

12. The optical access network system according to claim 8, wherein the upstream signals are modulated in a Non-Return-to-Zero (NRZ) format.

13. The optical access network system according to claim 4, wherein the upstream signals are modulated in a Return-to-Zero (RZ) format.

14. The optical access network system according to claim 5, wherein the upstream signals are modulated in a Return-to-Zero (RZ) format.

15. The optical access network system according to claim 7, wherein the upstream signals are modulated in a Return-to-Zero (RZ) format.

16. The optical access network system according to claim 8, wherein the upstream signals are modulated in a Return-to-Zero (RZ) format.
